(19) United States
(12) Patent Application Publication
(10) Pub. No.: US 2025/0309386 A1
(43) Pub. Date: Oct. 2, 2025

(54) GAS MITIGATION FOR BATTERY SYSTEMS

(71) Applicant: FORD GLOBAL TECHNOLOGIES, LLC, Dearborn, MI (US)

(72) Inventors: Qian ZHOU, Northville, MI (US); Gang GUO, Saline, MI (US); Kent SNYDER, Dearborn, MI (US); Giovanni CAVATAIO, Dearborn, MI (US)

(21) Appl. No.: 18/618,975

(22) Filed: Mar. 27, 2024

(51) Int. Cl. H01M 10/52; H01M 10/052; H01M 10/0565; H01M 10/42

(52) U.S. Cl. CPC H01M 10/523; H01M 10/052; H01M 10/0565; H01M 10/4235

(57) ABSTRACT

This disclosure relates to systems and methods for hydrogen sulfide mitigation. A battery cell or plurality of battery cells in a battery pack with a sulfur-containing lithium-based rechargeable battery component is presented. A monolith hydrolyzes hydrogen sulfide gas, precipitated from moisture exposure to the sulfur-based cathode, into sulfur dioxide and water, and releases the sulfur dioxide and water external to the battery cell.

### TECHNICAL FIELD

This disclosure relates to methods of byproduct mitigation for a battery pack.

### BACKGROUND

The lithium-sulfur (Li—S) battery has promising theoretical specific energy and availability. However, a challenge associated with lithium-sulfur batteries is the potential formation of hydrogen sulfide (H₂S) gas when these batteries are exposed to water or moisture. This is due to the interaction between the sulfide-based solid-state electrolyte or the sulfur cathode and moisture, leading to the generation of H₂S. The release of H₂S may reduce performance and longevity of the battery systems.

### SUMMARY

In one aspect of the disclosure, a sulfur-containing lithium-based rechargeable battery cell is presented. The sulfur-containing lithium-based rechargeable battery cell has a solid electrolyte sandwiched between an anode and a cathode. The battery cell also has a monolith configured to hydrolyze hydrogen sulfide gas, precipitated from moisture exposure to the cathode, into sulfur dioxide and water, and release the sulfur dioxide and water external to the battery cell. The monolith may include a plurality of channels extending therethrough. The channels within the plurality of channels may be arranged to allow direct passage of gases in a flow-through configuration. The plurality of channels may be arranged to allow gases to pass through porous walls in a wall-flow configuration. The monolith may include catalyst material. The monolith may include a plurality of channels coated with the catalyst material extending therethrough. The catalyst material may be Ni/Ce, Cu/Zeolite, and Fe/Zeolite individually or in combination. The solid electrolyte may be an inorganic solid electrolyte, solid polymer electrolyte, composite polymer electrolyte, sulfur-based solid electrolyte, or lithium.

In another aspect of the disclosure, a battery cell is presented. The sulfur-containing lithium-based rechargeable battery cell has a plurality of sulfur-containing lithium-based rechargeable battery cells. The sulfur-containing lithium-based rechargeable battery cell also has a monolith configured to hydrolyze hydrogen sulfide gas, precipitated from moisture exposure to the plurality of sulfur-containing lithium-based rechargeable battery cells, into sulfur dioxide and water, and release sulfur dioxide and water external to the battery pack. The monolith may include a plurality of channels extending therethrough. The channels may be arranged to allow direct passage of gases in a flow-through configuration. The channels are arranged to allow gases to pass through porous walls in a wall-flow configuration. The monolith may include catalyst material. The monolith may have a plurality of channels coated with the catalyst material extending therethrough. The catalyst material may be Ni/Ce, Cu/Zeolite, and Fe/Zeolite individually or in combination. The solid electrolyte may be an inorganic solid electrolyte, solid polymer electrolyte, composite polymer electrolyte, sulfur-based solid electrolyte, or lithium.

In yet another aspect of the disclosure, a method is presented, with a first step of directing hydrogen sulfide gas, precipitated from moisture exposure to a plurality of sulfur-containing lithium-based rechargeable battery cells, through channels of a monolith configured to hydrolyze the hydrogen sulfide gas into sulfur dioxide and water, and releasing the sulfur dioxide and water external to the plurality of the sulfur-containing lithium-based rechargeable battery cells. The channels within the monolith may be arranged in a flow-through configuration to allow direct passage of gases. The channels within the monolith may be arranged in a wall-flow configuration to allow gases to pass through porous walls. The directing step may include using a fan or pump to facilitate the flow of hydrogen sulfide gas through the monolith.

### BRIEF DESCRIPTION OF THE DRAWINGS

FIG. 1 is a diagram of an experimental setup;

FIG. 2A is a table of sensor readings for control samples;

FIG. 2B is a graph of sensor readings for control samples;

FIG. 3A is a table of sensor readings for catalyst materials investigated for use with any one or more embodiments of the disclosure;

FIG. 3B is a graph of sensor readings for catalyst materials investigated for use with any one or more embodiments of the disclosure;

FIG. 4. is a schematic view of a battery pack according to one embodiment of the disclosure;

FIG. 5. is a schematic view of a battery cell according to one embodiment of the disclosure;

FIGS. 6A and 6B are monolith configurations according to one or more embodiments of the disclosure; and

FIG. 7 is a flowchart of a method according to one embodiment of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Effective management of hydrogen sulfide (H₂S) gas may increase the efficiency of battery systems, particularly in those utilizing lithium-sulfur technology. H₂S, a potential byproduct arising from the interaction of sulfur-based battery components with moisture, poses significant challenges to both the performance and reliability of battery systems. To effectively mitigate any performance effects it may have on the battery, the adoption of catalytic materials is proposed. Among these, Ni/Ce, Cu/Zeolite, and Fe/Zeolite have shown potential, either used individually, in combination, or alongside other catalysts, for their efficacy in absorbing and transforming H₂S gas.

The approach of utilizing monolith catalytic converters for the mitigation of H₂S within battery packs is presented. The catalysts may be arranged at the outlet of the battery pack to maximize exposure to the evolving H₂S gas during both normal operational and other operational conditions. An example configuration of the monolith catalyst may have a multitude of channels through which the gas flows from inlet to outlet. This configuration may facilitate direct contact between the flowing gas and the catalysts coated on the channel surfaces. Catalytic reactions occur to convert the H₂S into hydrogen and sulfur. The incorporation of active materials into the monolith catalyst may be done by coating the surface of the monolith substrate, typically extruded from cordierite, or by mixing the active materials with the substrate prior to extrusion, resulting in a multi-channel monolith structure.

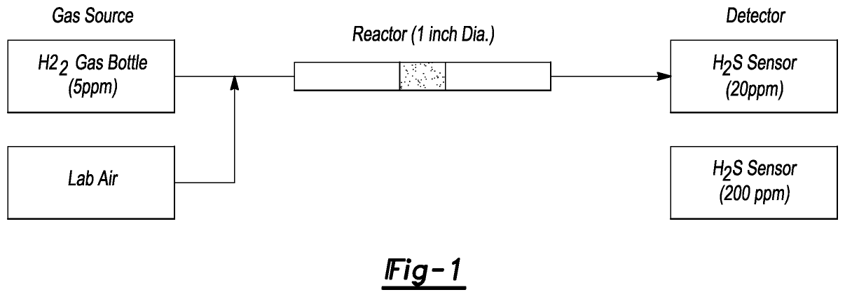

In an endeavor to understand the efficiency and functionality of various catalysts in the absorption of H₂S, an experimental setup was established as depicted in FIG. 1. This setup aimed to closely mimic the conditions under which these catalysts would operate within a battery pack environment, focusing on their ability to mitigate H₂S emissions. The experiment utilized a gas source to mix H₂S with laboratory air, delivering it at an amount of 5 parts per million (ppm) and a flow rate of 1000 ml/min through a reactor. This reactor, with dimensions of 1 inch in diameter and length, was subjected to the gas mixture and then linked to a sensor designed to measure the H₂S levels emitted post-reactor interaction. The experimental setup also included the use of a video camera to continuously record the H₂S sensor readings and the corresponding time, enabling the construction of an H₂S versus Time Curve for each test condition.

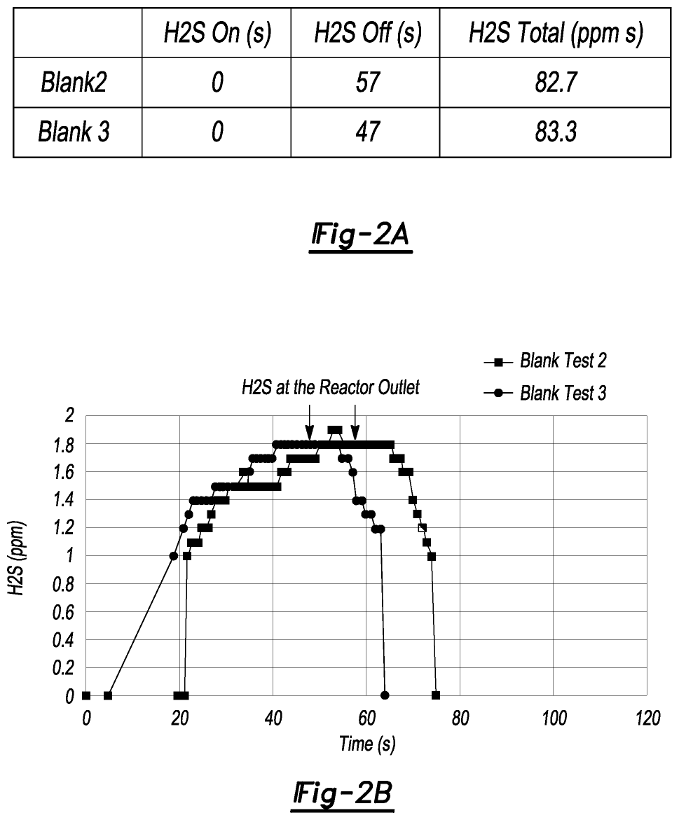

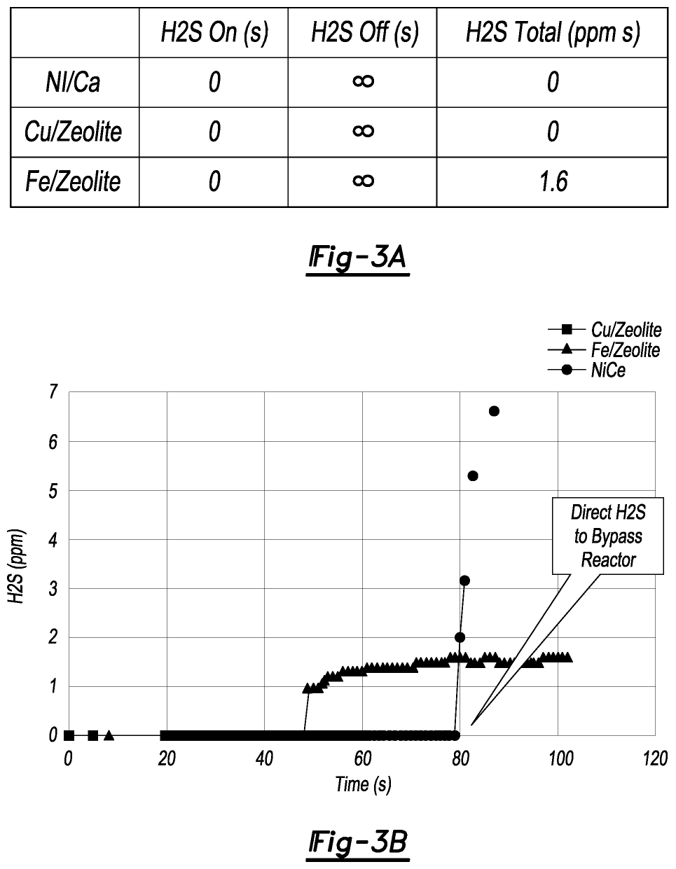

Prior to the introduction of any catalyst materials into the reactor, a background test was conducted using a blank reactor setup to establish a baseline for H₂S emissions. This was followed by individual tests for each of the selected catalyst materials: Ni/Ce, Cu/Zeolite, and Fe/Zeolite. The findings from the background tests, as illustrated in FIGS. 2A and 2B, showed H₂S readings of 82.7 and 83.3 ppm after 57 and 47 seconds, respectively, indicating the presence of H₂S in the absence of a catalyst. In contrast, the implementation of catalyst materials within the reactor showed a reduction in H₂S emissions. As seen in FIGS. 3A and 3B, the presence of Ni/Ce and Cu/Zeolite catalysts within the reactor material resulted in minimal H₂S readings at the sensor even after extended periods of gas release. This difference underscores the effectiveness of these catalysts in absorbing H₂S under the test conditions, which were set to closely replicate room temperature environments. Both Ni/Ce and Cu/Zeolite demonstrated the ability to absorb H₂S effectively at room temperature, as evidenced by the minimal H₂S readings recorded after the gas passed through reactors containing these catalysts. Fe/Zeolite was found to be less effective in absorbing H₂S under the same temperature conditions. The choice of catalyst selected may be influenced by environmental conditions of the application site and desired outcomes.

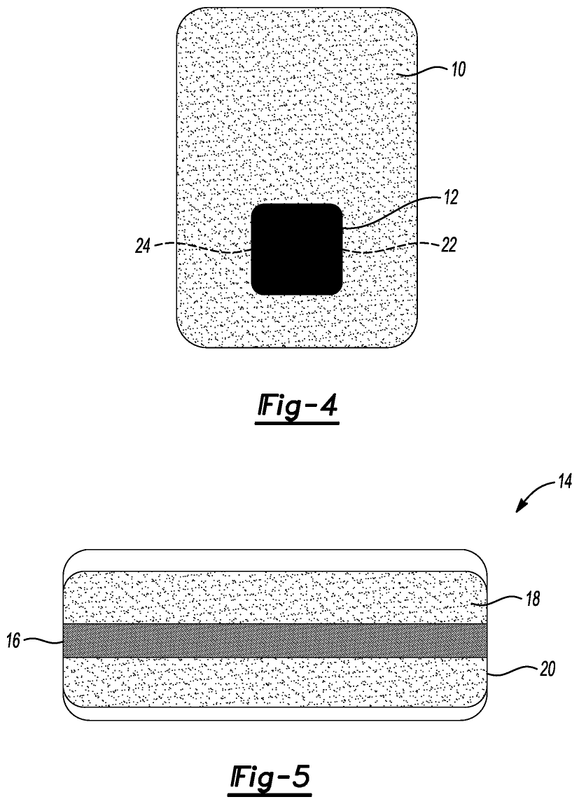

Referring to FIGS. 4-5, FIG. 4 is a schematic view of a battery pack 10 with a monolith 12. The battery pack 10 has individual cells 14. As shown in FIG. 5, each of the individual cells 14 within the battery pack 10 is a sulfur-containing lithium-based rechargeable battery cell with a solid electrolyte 16 sandwiched between an anode 18 and a cathode 20. The solid electrolyte 16 may be any compatible electrolyte such as inorganic solid electrolyte (ISE), solid polymer electrolyte (SPE), or composite polymer electrolyte (CPE). The monolith 12 is configured to mitigate hydrogen sulfide gas generation, a byproduct of moisture interaction with the cathode 20. The monolith 12 is configured to do this through the incorporation of catalyst materials 22 hydrolyzing hydrogen sulfide gas into sulfur dioxide and water. The sulfur dioxide and water are subsequently released external to the battery cell 14 or battery pack 10. Mitigating the hydrogen sulfide externally may help to preserve the cell's integrity and lifespan. The catalyst materials 22 that may be used are Ni/Ce, Cu/Zeolite, Fe/Zeolite individually or in combination, to facilitate the hydrolyzation of hydrogen sulfide gas into sulfur dioxide and water. The incorporation of catalyst materials 22 into the monolith 12 may be done by extruding the catalyst materials 22 with a substrate material 24 such as cordierite. The substrate material 24 may also be coated with catalyst materials 22.

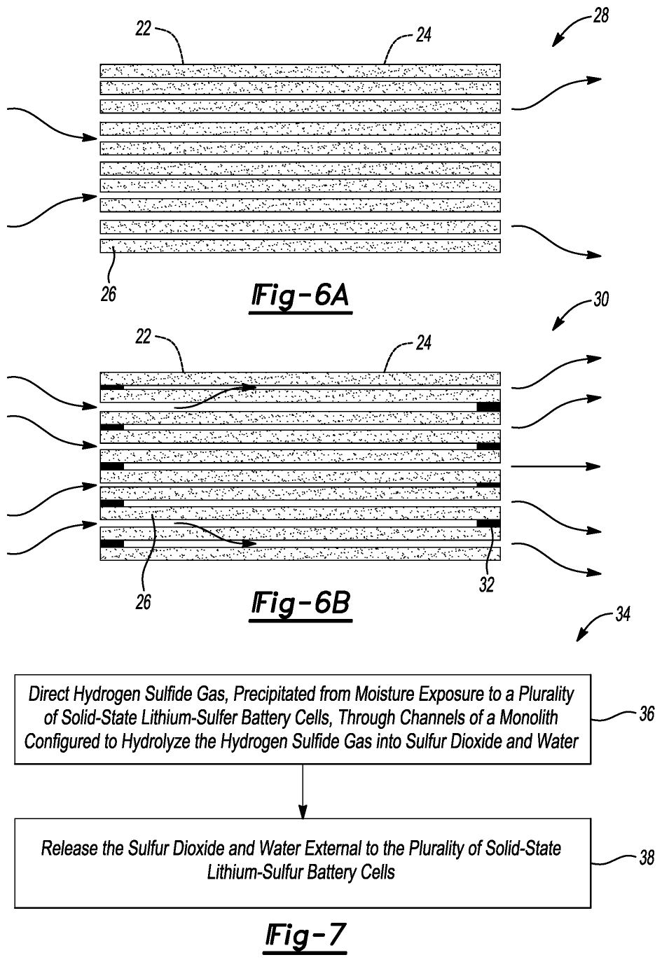

The monolith 12 may have channels 26, as shown in FIGS. 6A and 6B, the channels 26 may be configured in different ways to optimize the gas treatment process within the battery pack 10. FIG. 6A illustrates a monolith configuration 28 where the monolith 12 includes the plurality of channels 26 extending through it. These channels 26 are structured to facilitate a direct flow-through configuration, allowing gases to pass directly through the channels 26, to maintain efficient gas movement and reaction within the monolith 12. FIG. 6B, shows a configuration 30 where the channels 26 within the monolith 12 are designed to allow gases to pass through porous walls 32 in a wall-flow configuration. This arrangement may be effective in maximizing the contact surface area between the hydrogen sulfide gas and the catalyst materials 22 coated along the channels 26, affecting the hydrolyzation process.

FIG. 7 illustrates a flowchart of a method 34 for H₂S mitigation in lithium-sulfur batteries according to one aspect of the disclosure. In block 36 hydrogen sulfide gas, precipitated from moisture exposure to a plurality of sulfur-containing lithium-based rechargeable battery cells, is directed through channels of a monolith configured to hydrolyze the hydrogen sulfide gas into sulfur dioxide and water. In block 38 the sulfur dioxide and water are released external to the plurality of sulfur-containing lithium-based rechargeable battery cells. The channels within the monolith may be arranged in a flow-through configuration to allow direct passage of gases. Alternatively, the channels within the monolith may be arranged in a wall-flow configuration to allow gases to pass through porous walls. In some embodiments, the directing step may include using a fan or pump to facilitate flow of hydrogen sulfide gas through the monolith.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery cell comprising:
a sulfur-containing lithium-based rechargeable battery; and
a monolith configured to hydrolyze hydrogen sulfide gas, precipitated from moisture exposure to the cathode, into sulfur dioxide and water, and release the sulfur dioxide and water external to the sulfur-containing lithium-based rechargeable battery cell.

2. The battery cell of claim 1 wherein the monolith includes a plurality of channels extending therethrough.

3. The battery cell of claim 2 wherein the channels are arranged to allow direct passage of gases in a flow-through configuration.

4. The battery cell of claim 2 wherein the channels are arranged to allow gases to pass through porous walls in a wall-flow configuration.

5. The battery cell of claim 1 wherein the monolith includes catalyst material.

6. The battery cell of claim 5 wherein the monolith includes a plurality of channels coated with the catalyst material extending therethrough.

7. The battery cell of claim 5 wherein the catalyst material is Ni/Ce, Cu/Zeolite, or Fe/Zeolite individually or in combination.

8. The battery cell of claim 1 wherein the solid electrolyte is selected from the group consisting of inorganic solid electrolyte, solid polymer electrolyte, composite polymer electrolyte, sulfur-based solid electrolyte, and lithium.

9. A battery pack comprising:
a plurality of sulfur-containing lithium-based rechargeable battery cells; and
a monolith configured to hydrolyze hydrogen sulfide gas, precipitated from moisture exposure to the plurality of battery cells, into sulfur dioxide and water, and release sulfur dioxide and water external to the battery pack.

10. The battery pack of claim 9 wherein the monolith includes a plurality of channels extending therethrough.

11. The battery pack of claim 10 wherein the channels are arranged to allow direct passage of gases in a flow-through configuration.

12. The battery pack of claim 10 wherein the channels are arranged to allow gases to pass through porous walls in a wall-flow configuration.

13. The battery pack of claim 9 wherein the monolith includes catalyst material.

14. The battery pack of claim 13 wherein the monolith includes a plurality of channels coated with the catalyst material extending therethrough.

15. The battery pack of claim 13 wherein the catalyst material is Ni/Ce, Cu/Zeolite, or Fe/Zeolite individually or in combination.

16. The battery pack of claim 9 wherein the solid electrolyte is selected from the group consisting of inorganic solid electrolyte, solid polymer electrolyte, composite polymer electrolyte, sulfur-based solid electrolyte, and lithium.

17. A method comprising:
directing hydrogen sulfide gas, precipitated from moisture exposure to a plurality of sulfur-containing lithium-based rechargeable battery cells, through channels of a monolith configured to hydrolyze the hydrogen sulfide gas into sulfur dioxide and water; and
releasing the sulfur dioxide and water external to the plurality of sulfur-containing lithium-based rechargeable battery cells.

18. The method of claim 17 wherein the channels within the monolith are arranged in a flow-through configuration to allow direct passage of gases.

19. The method of claim 17 wherein the channels within the monolith are arranged in a wall-flow configuration to allow gases to pass through porous walls.

20. The method of claim 17 wherein the directing includes using a fan or pump to facilitate flow of hydrogen sulfide gas through the monolith.
